(19) United States
(12) Patent Application Publication
(10) Pub. No.: US 2015/0051926 A1
(43) Pub. Date: Feb. 19, 2015

(54) Method And System For Managing Parking Spaces In The Context Of Automated Vehicle Rental, And Vehicle Rental Facility

(71) Applicant: Bluecarsharing, Vaucresson (FR)

(72) Inventors: Francis Aaron, Houilles (FR); Julien Rouyer, Puteaux (FR); Sandrine Ressayre, Auffargis (FR); Clement Lambrinos, Montreuil (FR); Yousra Chebbi, Issy Les Moulineaux (FR); Aymeric Augustin, Ville D'Avray (FR); Raphael Barrois, Paris (FR); Sylvain Geron, Meudon (FR); Antoine Geron, Viroflay (FR)

(73) Assignee: BLUECARSHARING, Vaucresson (FR)

(21) Appl. No.: 14/348,016

(22) PCT Filed: Sep. 27, 2012
(86) PCT No.: PCT/FR2012/052173

§ 371 Date: Mar. 27, 2014

(30) Foreign Application Priority Data
Sep. 30, 2011 (FR) 11 58784

(51) Int. Cl. G06Q 10/02; G06Q 30/06; G08G 1/14

(52) U.S. Cl. CPC G06Q 10/02; G08G 1/142; G06Q 30/0645
USPC 705/5

(57) ABSTRACT

The invention relates to a method (200) for managing parking spaces in the context of automated rental of vehicles offered for rent at a plurality of so-called rental sites, each of said rental sites including at least one parking space, said method (200) being characterized in that it includes the following steps for at least one rental site: determining (202) a so-called availability data item relating to the existence or non-existence of an available parking space at said rental site, transmitting (212, 218) said availability data item to at least one vehicle being rented, and displaying (220) said availability data item for said at least one vehicle. The invention likewise relates to a system implementing such a method and to a use of such a method and such a system for automated vehicle rental.

The present invention relates to a method for managing parking spaces within the context of the automated rental of vehicles. It also relates to a system implementing such a method and an installation incorporating such a method and system.

The field of the invention is the field of the automated rental of vehicles, and more particularly managing parking spaces for the vehicles available for rental over a plurality of rental sites. By “rental site”, is meant any site enabling the collection of a rental vehicle or the return of a vehicle at the end of rental.

### STATE OF THE ART

Automated vehicle rental is a field experiencing rapid growth. In population centres where it is desirable to reduce the number of vehicles present in the area, automated vehicle rental systems are being established.

Installations for the rental of cycles are currently known. These installations comprise several rental sites, dispersed in a geographical area, and allowing users to collect a rental cycle or return a cycle at the end of rental. Thus, a user can collect a rental vehicle at a first site, use it during the rental period, and return it, at the end of rental, to a second rental site different from the first rental site.

The known rental sites comprise parking spaces arranged in order to receive a vehicle when the latter is no longer being rented. Each parking space is designed to receive a single vehicle. The reason for such a design is to ensure individual automated rental of the vehicles available for rental without human intervention. Thus, each rental site cannot receive more vehicles than there are parking spaces.

Such a situation can result in the overloading of a rental site, no longer allowing a user to return a rented vehicle there. The user finding himself in such an inconvenient situation then has to search for another rental site in order to return his vehicle there and terminate the rental. During this time, the vehicle still remains under rental and the user can be charged the corresponding amount. Moreover, the search for an available parking space constitutes what can be a significant waste of time, especially when no other rental site is situated close to the overloaded rental site.

A purpose of the present invention is to overcome the abovementioned drawbacks.

Another purpose of the invention is to propose a method and a system for managing parking spaces within the context of automated rental of vehicles allowing better management of the automated rental of a vehicle.

Finally another purpose of the invention is to propose a method and a system for managing parking spaces within the context of automated rental of vehicles making it possible to reduce the costs to users, associated with vehicle rental.

### DISCLOSURE OF THE INVENTION

The invention proposes to achieve at least one of the abovementioned purposes by a method for managing parking spaces within the context of automated rental of vehicles available for rental over a plurality of sites, called rental sites, each of said rental sites comprising at least one parking space, said method being characterized in that it comprises, for at least one rental site, the following steps:
determining an item of data, called availability data, relating to the presence or not of an available parking space at said rental site,
transmitting said item of availability data to at least one currently rented vehicle, and
displaying said item of availability data in said at least one vehicle.

Thus, the method according to the invention allows a user to avoid the inconvenient situation described above, and to be notified of the availability of rental sites before going there, on the one hand to avoid going to an unavailable rental site, and on the other hand to identify an available rental site in order to return his vehicle there and terminate the rental.

The method according to the invention avoids a user having to search for an available parking site during a period of time for which he will be charged, which reduces the cost associated with the rental of the vehicle and the waste of time for the user.

The method according to the invention thus allows users to better manage the automated rental of vehicles, by guiding them until the end of rental.

By “available” rental site is meant a rental site comprising at least one parking space that is “available”, i.e. not occupied by another vehicle and not reserved.

It will be noted that, in the remainder of the text, the terms “parking place” and “parking space” will be used interchangeably. Similarly, “station” and “rental site” are used to denote the same entity of the installation according to the invention.

Advantageously, the method according to the invention can be initiated:
at the request of a user, and/or
periodically at a predetermined frequency, and/or
at each change of value of the item of availability data, for example at each arrival or departure of a vehicle at the rental site.

Thus, it is possible for the user to know the availability status of the rental sites at all times, and even in real time.

Advantageously, for at least one rental site, the item of availability data, in particular the item of availability data displayed in the vehicle, can comprise an item of data that is:
Boolean, indicating if a parking space is available there or not, for example of the “available”, “unavailable” type, and/or
numerical, indicating the number of parking spaces available at said rental site, and/or
an item of colour data, for example “green” for available and “red” for unavailable.

Thus, it is possible for the user to rapidly visualize the status of each parking site if he so wishes.

Advantageously, for at least one rental site, the step of transmitting an item of availability data can be carried out, in particular via a wireless communication network, of GPRS type:
directly from said rental site to at least one currently rented vehicle, for example from a rental terminal of said rental site to the vehicle or vehicles,
via a remote site, called the central site.

In a first embodiment, the method comprises transmitting said item of availability data from said rental site to said central site, then from said central site to said vehicle.

When transmitting the item of availability data to the vehicles is carried out by the central site, the data originating from each rental site can be collected in a central server, which then sends the set of data to each of the vehicles.

Advantageously, in this case, for at least one rental site, the item or items of availability data transmitted can comprise only modifications with respect to the last data transmission and, optionally, if no modification has taken place, an item of data indicating this. Thus, instead of transmitting all of the availability data each time, only the modifications are reported, which reduces the quantity of data exchanged during data transmissions between the rental site, optionally the central site, and the vehicles.

In a second embodiment, the central site carries out the step of determination on the basis of data it holds, particularly on the basis of data transmitted by the rental site.

In this case, the central site produces a synthesis of the items of availability data from several rental sites and transmits to the vehicles only the modifications with respect to the previous transmitting data.

Before each step of determining the item of availability data, the method comprises a step of determining the status of each of the parking spaces of the station. The item of availability data is determined using these statuses optionally combined with the total number of parking spaces in said rental site.

The availability status of at least one parking space can be determined according to at least one of the following options:
by measuring an item of data of the presence of a vehicle in said parking place of said rental site, for example by a presence detection camera, an infrared sensor, a weighing device, a current loop, etc. such measuring of an item of presence status data preferably carried out at the rental site, and/or
when said parking place is provided with charging means, called a charging terminal, by detecting an electrical connection of said charging terminal to a vehicle, for example by the use of a pilot wire, such a detection being preferably carried out at the rental site, and
optionally, by consulting a database indicating if said parking place is reserved or not, consultation being able to be carried out at the rental site or at the central site.

In a comprehensive embodiment, the availability status of a parking space is determined by the use of all of the options combined with each other.

In the case where the item of availability data is determined at the central site, and the availability status of each parking place is determined at the rental site, the method according to the invention comprises moreover transmitting the availability status of each parking place from the rental site to the central site, the central site then producing a synthesis of all of these data and determining the item of availability data for each of the rental sites.

Advantageously, for at least one rental site, the item of availability data can be displayed on a map, together with the position of said rental site on said map.

In this embodiment, the vehicle also receives the location data of at least one rental site from the central site or from the rental site.

These location data can also be pre-programmed in the vehicle.

Thus, it is possible for the user to know both the availability of a rental site and its position, for example in relation to a destination. It is then possible for the user to know the availability status of all of the rental sites near his destination and thus to plan with a view to returning the vehicle that he has rented and terminating the rental.

The item of availability data displayed for at least one rental site, and advantageously for each of the rental sites, can be an item of colour data, “green” or “red”, an item of data indicating the number of available parking spaces or a combination of these options.

In a particularly advantageous version, the method according to the invention can comprise a display of the item or items of availability data relating to:
the rental site or sites situated at a distance less than or equal to a threshold distance in relation to the position of the vehicle or in relation to a previously notified destination, or
the rental site nearest to the position of the vehicle or to a previously notified destination, or
a rental site previously selected by the user.

In the first two cases, the method according to the invention can comprise a selection of the rental sites in question as a function of the destination indicated, and optionally of the threshold distance, prior to displaying the availability data.

When the user has selected an arrival rental site, the method according to the invention can moreover advantageously comprise at least one of the following functions:
when the user has also indicated the precise destination to which he wishes to go, notification of the user when a parking space becomes free at a rental site nearer than the rental site previously selected as the arrival site, this rental site then being able to become, optionally with the approval of the user, the new arrival site, and
notifying the user when a selected rental site no longer has any spaces available.

The method according to the invention can moreover advantageously comprise guiding the user to a selected rental site or a rental site having at least one parking space available.

In a preferred version, the method according to the invention can moreover comprise a step of reserving a parking space from a currently rented vehicle. Such a reservation can also be made from a rental site during or just before the rental of the vehicle.

The reservation data can be then be transmitted either directly to the rental site, or via the central site.

The reservation data can comprise an identifier of the vehicle or an identifier of the user.

The reservation can be made for a predetermined period, for example 90 minutes, said period moreover being able to be variable as a function of the proximity of the parking space.

The reservation can be requested by the user from the vehicle, by means of a call to an operator of the rental service or directly by means of a vehicle interface. Such an interface can also be the interface for displaying the items of availability data from the rental sites.

For this, a reservation request is sent from the vehicle to a rental site, optionally via the central site, the rental site then changing the “available” status of the parking place to a “reserved” status. Such a “reserved” status then renders the parking place “unavailable” and prevents any other user from gaining access to the parking place and, in the case of the automated rental of electric vehicles, to the charging terminal of the parking place.

According to the invention, when a “reserved” status exists, the parking place declared to be “available” is a parking space which is neither occupied by a vehicle, nor reserved by a user.

According to another aspect of the invention a system is proposed for managing parking spaces within the context of automated rental of vehicles available for rental over a plurality of sites, called rental sites, each of said rental sites comprising at least one parking space, said system being characterized in that it comprises:
means for determining an item of data, called availability data, relating to the presence or not of a parking space available at at least one rental site,
means for transmitting said item of availability data to at least one currently rented vehicle, and
means for displaying said item of availability data in said at least one vehicle.

In an advantageous embodiment of the system according to the invention, the means for determining the item of availability data can comprise:
for each rental site:
   means for detecting the presence of a vehicle, for example weighing means and/or a camera, and/or means for detecting an electrical connection at each parking place, for example a pilot wire in particular when the rented vehicles are electric vehicles, and
   a terminal, called a rental terminal, in communication with said detection means; and
for all of the rental sites, a common server, called a management server, arranged at a site, called a central site, remote from said rental sites and in communication with the rental terminal of each rental site via a communication network, for example a LAN-type wired network.

The means for determining the item of availability data can also comprise a database, at each of the rental sites or at the central site, intended to store if a parking space is reserved or not.

Advantageously, the means for transmitting the item or items of availability data can comprise a communication module, called a central module, arranged at a site, called a central site, remote from the rental sites.

Such a communication module can comprise a SIM card or equivalent for communicating via a GPRS-type network.

The transmission means can also comprise, for each vehicle, a communication module, called a vehicle communication module, for example of GPRS type, placed in the vehicle and arranged in order to receive the data transmitted by the central communication module and to transmit data, for example reservation data, to the central communication module.

Advantageously, the display means can comprise a user interface, arranged for:
displaying the item of availability data of a rental site on a map and at the location of said rental site, and/or
selecting a rental site with a view to reserving a parking space, and/or
guiding the user to a previously selected rental site.

Such an interface can be an interface of a GPS-type global positioning means.

According to yet another aspect of the invention an installation is proposed for the automated rental of vehicles comprising a plurality of rental sites each comprising at least one parking space and a plurality of vehicles intended to be collected from and returned to the parking spaces of the rental sites, said installation comprising a management system according to the invention or comprising the means for implementing the method according to the invention.

Other advantages and characteristics of the invention will become apparent on examination of the detailed description of embodiments which are in no way limitative, and the attached drawings, in which:

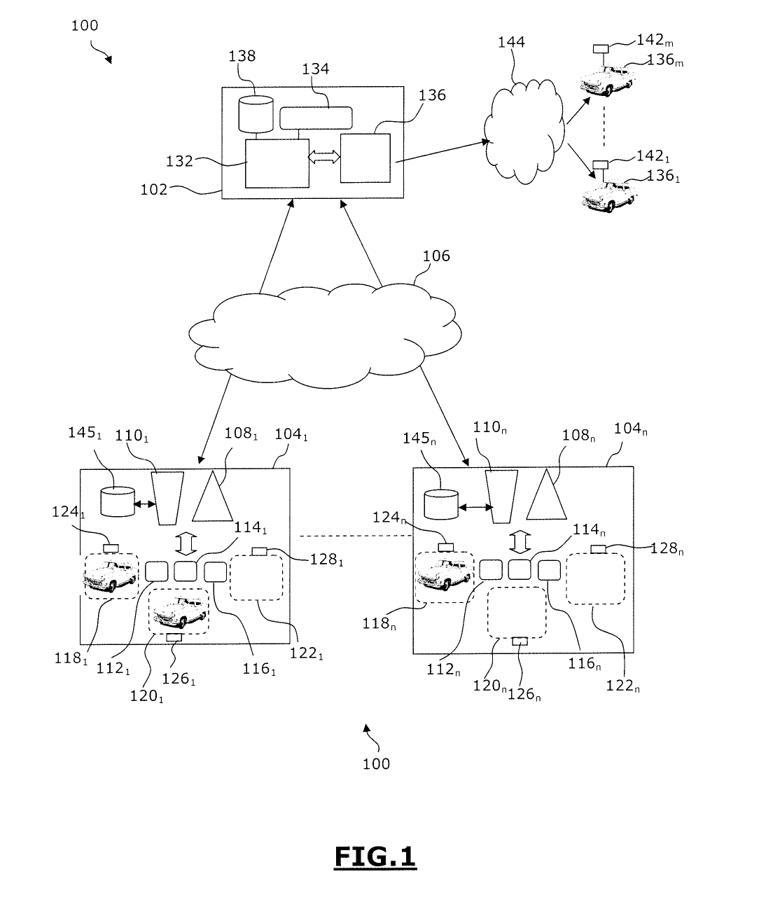

FIG. 1 is a diagrammatic representation of a vehicle rental installation implementing the method according to the invention;

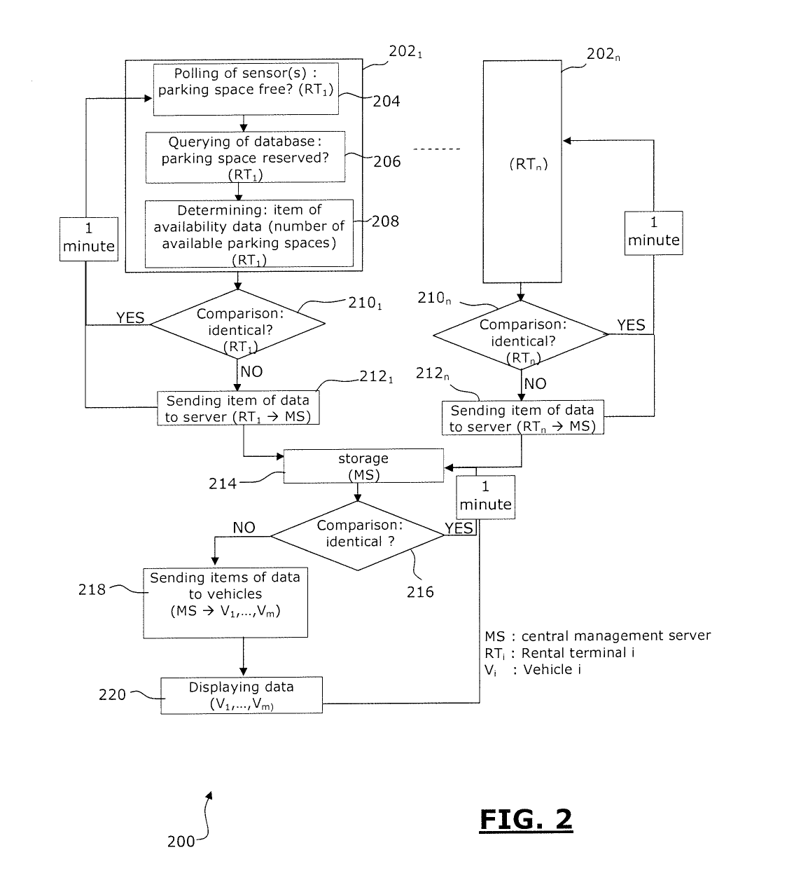

FIG. 2 is a diagrammatic representation in the form of a flow chart, of a management method according to the invention.

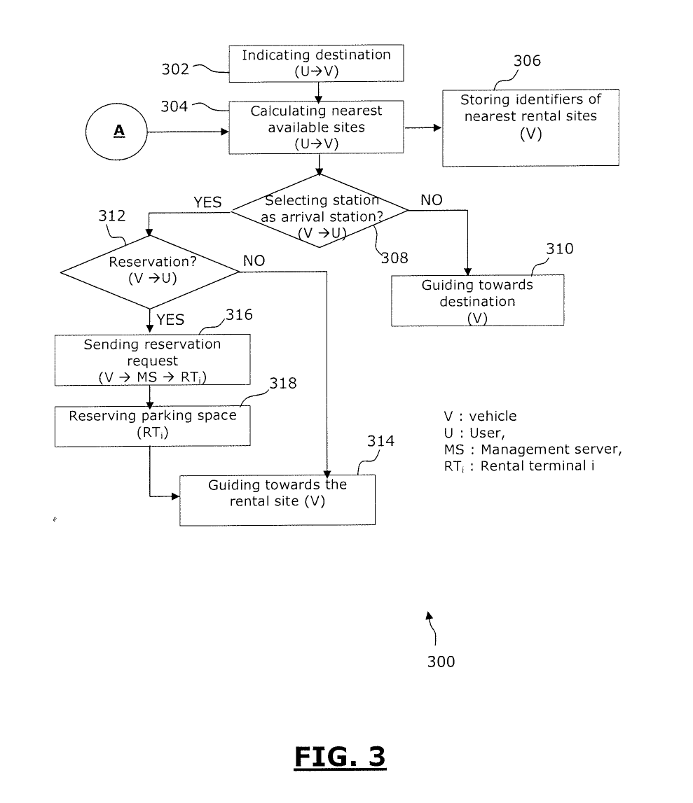

FIG. 3 is a diagrammatic representation in the form of a flow chart, of a phase of reserving a parking space within the context of a method according to the invention; and

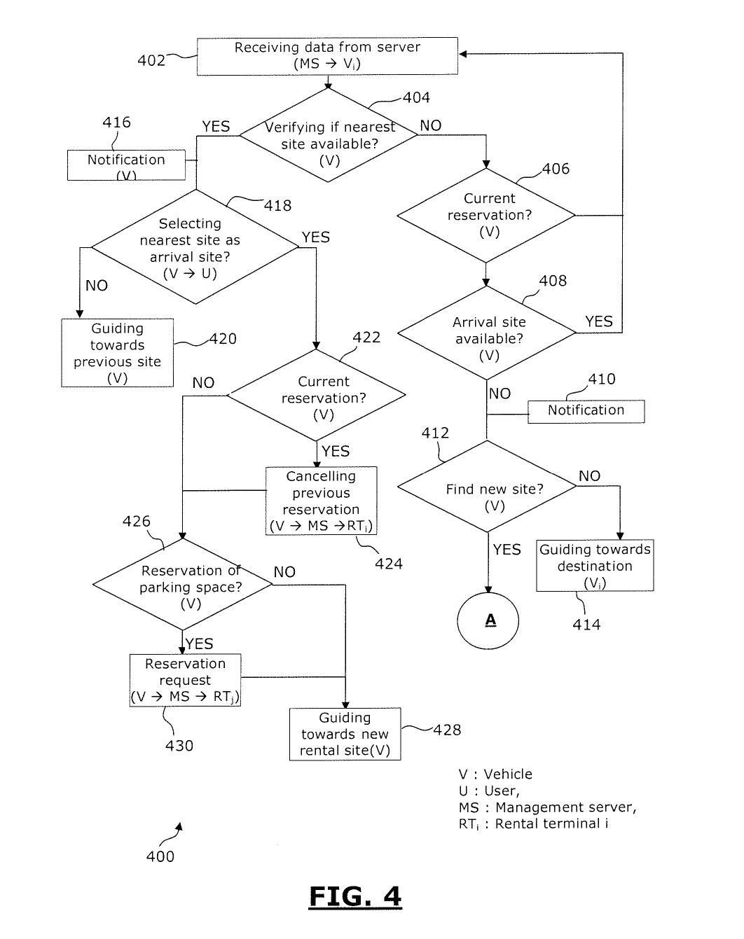

FIG. 4 is a diagrammatic representation in the form of a flow chart, of a phase of modification of a reservation carried out according to the phase of reservation in FIG. 3.

It is understood that the embodiments which will be described below are in no way limitative. In particular, variants of the invention can be envisaged that comprise only a selection of the features described below in isolation from the other features described, if this selection of features is sufficient to provide a technical advantage or to differentiate the invention from the prior art. This selection comprises at least one preferably functional feature without structural details, or with only part of the structural details if this part alone is sufficient to confer a technical advantage or to differentiate the invention from the state of the prior art.

In particular all the variants and embodiments described can be combined with each other if there is no technical objection to this combination.

In the figures and in the remainder of the description, the elements common to several figures retain the same reference number.

The examples described below relate to automated rental of electric vehicles over several rental sites.

FIG. 1 is a diagrammatic representation of an automated electric vehicle rental system.

The installation 100 shown in FIG. 1 comprises a central site 102 connected to several sites—or stations—104₁-104ₙ, called rental sites via a wireless communication network 106, for example GPRS, or a wired network, for example of DSL or LAN type. Preferably, each site 104 is connected to the central site via two separate networks, which enables continuous connection even if one of the networks fails.

Each rental site 104 comprises a rental terminal 110 for the rental of a vehicle and several charging terminals 112-116, each charging terminal being provided for charging a vehicle equipped with an electric battery at a parking space, namely parking spaces 118-122.

Some rental sites 104 also comprise a subscription terminal 108 for registering a new subscriber.

Each parking space of a rental site 104 comprises a presence detector module 124-128, namely weighing means, a camera and/or an infrared sensor and/or a detector of an electrical connection to a vehicle, connected to the rental terminal 110 of the rental site 104.

The central site 102 can be connected directly to each of the terminals of a rental site 104 via the network 106 or only to the subscription terminal and/or to the rental terminal and/or to the recharging terminals 112-116.

At least two terminals of a rental site are connected to each other by means of a wired connection (not shown).

The central site 102 comprises a central management server 132, a synthesis module 134 and a communication module 136, called a central communication module. The central site 102 moreover comprises a database 138 in which, in association with each vehicle identifier, the identifier of the user to whom this vehicle is rented, and optionally the status of the vehicle (rented/not rented/undergoing maintenance) are saved.

The central site 102 is in communication with currently rented electric vehicles 140₁-140ₘ, via the central communication module 136 and a communication box 142₁-142ₘ, called a vehicle communication box, arranged in each of the vehicles, via a wireless communication network 144, for example GPRS, which can be the same as the communication network 106.

By means of the central communication module 136 and the vehicle communication modules 142, the central site exchanges data with each of the vehicles 140.

Each vehicle communication module 142 is in connection with a user interface (not shown), for example an interface of a global positioning element of the vehicle, which can comprise a touch screen, for displaying the data thereon on a map and for taking into account the data entries made by the user of the vehicle 140.

The installation 100 makes it possible to manage a plurality of vehicles available for rental.

Users are capable of interacting with the different terminals as well as with the different elements of the vehicles. Moreover, the vehicle rental service with the installation according to the invention can also be carried out with the help of operators who can intervene in the service by means of their mobile terminal such as a PDA.

Each rental site 104 comprises a database 145 in which the reserved or unreserved state of each parking spaces 118 of the rental site 104 is saved. This database could also make it possible to save the availability status of each parking space, namely occupied or free.

FIG. 2 is a diagrammatic representation of a method 200 for managing the parking spaces according to the invention, for example within the context of the installation of FIG. 1.

The method 200 comprises firstly a data-collection step 202ᵢ carried out by the rental terminal RTᵢ of each rental site. This terminal determines for each parking space of each of the rental sites, which one is occupied. Step 202 is therefore carried out for each of the parking spaces of the rental site, either simultaneously or one after the other.

This step 202₁ comprises:
a step 204ᵢ, during which the rental terminal polls a presence sensor allocated to a parking space, for example a current loop situated on the roadway, under the parking space or also, a detection sensor, such as a camera, situated for example on the charging terminal allocated to the parking space. The status of the parking space (free or occupied) can also be determined by detecting the connection of a vehicle to the charging means of the charging terminal allocated to the space. This type of detection does not however detect vehicles parked in the parking space in unauthorized manner, unlike detection using a presence sensor. It is also possible to poll both types of sensor simultaneously;
a step 206ᵢ during which a database is queried in order to determine if a free parking space is reserved or not; and
a step 208ᵢ during which the number of available parking spaces is counted, this number corresponding to the item of availability data for the site i.

After step 202ᵢ carried out for each of the parking spaces of the rental site, a step 210ᵢ carries out a comparison of the determined item of availability data with that determined previously.

If the items of data are identical, no data is sent and step 202ᵢ is repeated one minute later.

If there is a difference between the two items of availability data, the new item of availability data is communicated to the central site, and more particularly to the central management server, during a step 212ᵢ.

Steps 202-212 are carried out for each of the rental sites in parallel, either simultaneously or in staggered manner.

In step 214, the management server stores the received data in a database, for example the database 138 of FIG. 1. Each item of availability data for a rental site is saved in the database for example in association with an identifier of the rental site in question. The storage is carried out as the items of availability data are received from the different rental sites.

In step 216, the management server carries out a comparison between the data previously sent to the vehicles and the new availability data.

If the items of data are identical, no item of data is sent to the vehicles, and step 214 is repeated for example 1 minute later.

If the items of data are different, in step 218, the central management server sends, in the same transmission, the items of availability data for all the rental sites, to each vehicle in the fleet, namely to the rented vehicles and optionally to the vehicles which are not rented.

These data are then displayed in the vehicles in step 220 if the user so wishes.

Then step 214 is carried out periodically, particularly again 1 minute later.

It is also possible to envisage sending to the vehicles only the items of availability data which change, the availability data which do not change then not being sent. In this case, the vehicle display interface updates the display of the items of availability data for the rental sites to which the change relates, the display remaining unchanged for the other rental sites.

The data is sent to the vehicles by means of a wireless network such as a wireless telephone network (GPRS or 3G in particular).

As a variant, it is also possible to envisage that the reservation database is stored in the management server.

In this case, each rental site 104 sends to the management server the data of the occupation of the different parking spaces determined in step 202, following this step. Steps 204, 206 of consulting the reservation database and determining the status of each of the parking spaces, then of the item of availability data are then carried out by the management server.

The vehicle, in particular its user interface, has a GPS and stores in its memory the maps of the rental area. It also has GPS coordinates of the rental sites, also associated with their identifier, which makes it possible to the place them correctly on the map. It is also configured in order to incorporate the transmitted items of availability data into the map. Each item of availability data is displayed on the map in relation to the representation of the corresponding station, in particular in the vicinity of the location of the site on the map. These maps are displayed on the user interface in order to allow the user access thereto. It will be noted that it is possible for these items of data to be displayed only if the vehicle is in operation, and in particular if the user wishes them to be displayed, in particular within the context of the GPS function.

The items of availability data received in the vehicle can be stored in a memory in the vehicle, particularly in the user interface.

The items of availability data can also be downloaded in real time and as needed, by the user interface from the central management server.

The user of the vehicle therefore has access to information on the availability of the different rental sites in the rental area. He is thus better able to choose his itinerary.

FIG. 3 is a diagrammatic representation in the form of a flow chart, of a first embodiment of a phase of reservation of a parking space, that can be implemented within the context of a method according to the invention.

Such a reservation phase can be carried out following the steps described with reference to FIG. 2.

In fact, once the user has taken possession of the vehicle, he can use the vehicle's GPS function and indicate the destination to which he wishes to go.

The vehicle is then able to indicate to the user the nearest site with an available parking space. If the user validates this choice of station, the vehicle's GPS guides the user towards this station. Otherwise, it guides him towards the destination indicated, to which the user wishes to go.

For this the process 300 comprises a first step 302 during which the user indicates his destination on the user interface in the vehicle, for example by selecting on a touch screen or entering the address of his destination.

The user interface determines by calculation the available rental sites nearest to the destination, during step 304. For this, the user interface calculates the distance between each site of a set of preselected rental sites, those which have coordinates near to that chosen as arrival site for example, and the point of destination defined.

The identifiers of the nearest rental sites are stored in step 306, in storage means in the vehicle.

The user is then questioned in step 308 in order to determine if he wishes to indicate one of the rental sites as destination in this step.

If the user responds in the negative, then he is guided towards the destination that he previously indicated in step 310.

If the user chooses one of the rental sites as destination, the destination is changed and the new itinerary is determined. Moreover, he is questioned in step 312, in order to determine if he wishes to reserve a parking space on the rental site chosen.

If the user responds in the negative, he is then guided towards the rental site chosen in step 314.

If the user wishes to reserve a parking space, in step 316, a reservation request is sent to the rental terminal of the site chosen, optionally via the central management server. The reservation request comprises the identifier of the rental site, the identifier of the user and/or the identifier of the vehicle.

The parking space is reserved in step 318 and its “available” status is changed to “reserved”. Once the parking space is reserved, the charging terminal associated with the parking space can be controlled, for example via the rental terminal, so that the charging terminal displays a particular light indication, particularly by illuminating an LED or change of colour, in order to indicate the non-availability of the parking space to other users.

If there is no longer any parking space available, the rental terminal also changes its light signalling, particularly by lighting a lamp at the top for example, in order to inform users that no parking space is available at this station. Moreover, the rental terminal can at the same time send the central management server a new item of availability data indicating that the number of spaces available is zero.

It is also possible to initiate other operations such as for example, controlling the deployment of a retractable parking post preventing access to the reserved parking space, etc.

Finally, the user is guided towards the rental site in step 314.

The reservation can be made for a predetermined period, of fixed duration or calculated as a function of the distance separating the user from the rental site in question, for example 90 minutes. In this case, during the reservation step 316, a countdown is started at the central system or at the rental terminal, a command cancelling the arrangements made in the case of reservation being issued when the countdown expires. The user who has reserved the space can access the charging means before the expiry of the countdown by identifying himself to the rental terminal or the charging terminal comprising a reader of identification means. In order to do this, when a user identifies himself on one of the terminals of the rental site, in particular the rental terminal, the identifier read from the identification means is compared with that or those associated with the parking space reserved during the reservation and transmitted by the vehicle during the reservation. This comparison can be carried out at the central management server, the rental terminal having previously transferred the identifier read. If the identifier corresponds to that associated with a reserved parking space, the central server sends a command to the charging terminal corresponding to the reserved parking space, via the rental terminal and cancels the arrangements made for the reservation whilst allowing the opening of the lid containing the charging means or the means of access to the parking space.

The identification is preferably carried out using an identifier stored in an RFID chip, using a reader of such a chip, but it could be carried out by a barcode reader, or by entry of the identifier by the user.

The reservation procedure 300 described with reference to FIG. 3 can optionally comprise managing an optional change occurring during the journey.

FIG. 4 is a diagrammatic representation in the form of a flow chart, of a phase of modification of a reservation made according to the reservation phase of FIG. 3 following a change.

Such a change can occur for example if a parking space becomes free in a site nearer to the destination indicated or because the rental site selected no longer has a parking space available.

The reservation phase 400 comprises a step 402 of receiving from the management server news of items of availability data relating to the rental sites near to the destination.

During step 404, the user interface determines if a rental site nearer than that previously selected has a parking space available.

If not, the interface verifies if there is a current reservation in step 406.

If there is a current reservation, step 402 is repeated during the receiving of news of availability data. If there is no current reservation, the interface determines in step 408 if the rental site nearest to the destination indicated still has a parking space available. If this is the case, step 402 is repeated. If this is not the case, a notification is sent to the user during a step 410, and a step 412 asks the user if he wishes to search for a new arrival site. If the user wishes to search for a new site, the reservation phase 300 is carried out starting from step 304. If the user does not wish to search for a new rental site, a step 414 of guiding the user to the destination is carried out.

If following step 404, a rental site nearer to the destination than that which has been previously selected is identified, the user is notified during a step 416.

The interface questions the user, in step 418, in order to determine if he wishes to select the new rental site nearer to his destination as destination site. If the user does not wish to do so, then a step 420 guides the user towards the site previously selected as arrival destination.

If the user wishes to select the new site as destination site, the interface verifies if there is a current reservation in the previous rental site in step 422. If so, the reservation is cancelled by sending a cancellation message to the rental terminal RTᵢ of the previous rental site via the management server in step 424.

After the step 424 or if in step 422 there is no current reservation, the interface questions the user in order to determine if he wishes to reserve a parking space at the new rental site. If the user responds in the negative, a step 428 guides the user towards the new site selected as arrival site. Otherwise, during a step 430, a reservation request is issued to the rental terminal RTⱼ of the new rental site chosen as destination and the guiding step 428 is carried out.

As a variant, the step 424 of cancelling the reservation can be carried out after step 430 of reserving a parking space at the new rental site.

The step of reserving a parking space at a rental site can be carried out by means of a telephone communication with an operator, it being possible to call the operator from the vehicle.

The different steps of reservation and of notifying the user are optional.

Of course the invention is not limited to the examples which have just been described.

1. A method for managing parking spaces within the context of automated rental of vehicles available for rental over a plurality of sites, called rental sites, each of said rental sites including at least one parking space, said method comprising, for at least one rental site, the following steps:
determining an item of data, called availability data, relating to the presence or not of an available parking space at said rental site, said determining step comprising, for at least one parking space of said station, detecting at least one of:
the presence or not of a vehicle in said parking space by a presence sensor, or
an electrical connection of a vehicle to a charging means associated with said parking space;
transmitting said item of availability data to at least one currently rented vehicle via a wireless communication network; and
displaying said item of availability data in said at least one vehicle.

2. The method according to claim 1, wherein the method is initiated by at least one of:
the request of a user,
periodically at a predetermined frequency, or
each change of value of the item of availability data.

3. The method claim 1, wherein, for at least one rental site, the step of transmitting an item of availability data is carried out:
directly from said rental site to at least one currently rented vehicle,
via a remote site, called the central site.

4. The method according to claim 3, wherein, for at least one rental site, the item of availability data is determined at the remote site, called the central site, from items of data, at least some of which are transmitted by the rental site.

5. The method according to claim 1, further comprising, prior to the step of determining the item of availability data, determining an availability status of each of the parking spaces of the rental site.

6. The method according to claim 5, wherein the availability status of at least one parking space is determined by at least one of:
measuring an item of data of the presence of a vehicle in said parking space of said rental site,
when said parking space is provided with a charging means, called a charging terminal, by detecting an electrical connection of said charging terminal to a vehicle, or
consulting a database indicating if said parking space is reserved or not.

7. The method according to claim 1, wherein, for at least one rental site, the item of availability data is displayed on a map associated with the parking space of said rental site on said map.

8. The method according to claim 1, further comprising displaying the item or items of availability data relating to at least one of:
the rental site or sites situated at a distance less than or equal to a threshold distance in relation to the position of the vehicle or in relation to a previously notified destination,
the rental site nearest to the position of the vehicle or to a previously notified destination, or
a rental site previously selected by the user.

9. The method according to claim 1, further comprising at least one of the following steps, when the user has selected an arrival rental site:
when the user has also indicated his precise destination, notifying the user when a parking space becomes free at a rental site nearer than the rental site previously selected as arrival site, or
notifying the user when a selected rental site no longer has any parking spaces available.

10. The method according to claim 1, further comprising reserving a parking space at a rental site the item of availability data of which indicates that there is at least one parking space available, from a currently rented vehicle.

11. A system for managing parking spaces within the context of automated rental of vehicles available for rental over a plurality of sites, called rental sites, each of said rental sites including at least one parking space, said system comprising:
means for determining an item of data, called availability data, relating to the presence or not of a parking space available at at least one rental site, said means comprising, for at least one parking space, at least one of:
a presence sensor for detecting a presence or not of a vehicle in said parking space, or
a means for detecting an electrical connection of a vehicle to a charging means associated with said parking space;
means for transmitting said item of availability data to at least one currently rented vehicle, and
means for displaying said item of availability data in said at least one vehicle.

12. The system according to claim 11, wherein the means for determining the item of availability data comprise:
for each rental site:
means for detecting the presence of a vehicle or of an electrical connection at each parking place, and
a terminal, called a rental terminal, in communication with said detection means; and
for all of the rental sites, a common server, called a management server, arranged at a site, called a central site, remote from said rental sites and in communication with the rental terminal of each rental site via a communication network.

13. The system according to claim 11, wherein the means for transmitting the item of availability data comprise a communication module, called a central module, arranged at a site, called a central site, remote from the rental sites.

14. The system according to claim 11, wherein the display means comprise a user interface, comprising means for at least one of:
displaying the item of availability data of a rental site on a map at the parking space of said rental site,
selecting a rental site with a view to the reservation of a parking space, or
guiding the user towards a previously selected rental site.

15. An installation for the automated rental of vehicles comprising a plurality of rental sites each comprising at least one parking space and a plurality of vehicles intended to be collected from and returned to the parking spaces of the rental sites, said installation comprising a management system according to claim 11.
